(19) United States
(12) Patent Application Publication
(10) Pub. No.: US 2010/0057712 A1
(43) Pub. Date: Mar. 4, 2010

(54) INTEGRATED COMMUNITY-BASED, CONTRIBUTION POLLING ARRANGEMENT

(75) Inventor: Sridhar Ranganathan, Bangalore (IN)

Correspondence Address: Weaver Austin Villeneuve & Sampson - Yahoo!, P.O. BOX 70250, OAKLAND, CA, 94612-0250, US

(73) Assignee: YAHOO! INC., Sunnyvale, CA (US)

(21) Appl. No.: 12/202,743

(22) Filed: Sep. 2, 2008

(51) Int. Cl. G06F 7/06; G06F 17/30

(52) U.S. Cl. 707/5; 707/3; 707/E17.014

(57) ABSTRACT

Disclosed are apparatus and methods for facilitating online user polling over a computer network. In general, a particular web property is a web service or site that is related to a particular type of subject matter or service. A user of a particular web property can select a polling feature and initiate a query regarding a particular subject matter that is related to such particular web property. A set of online users-to-be-polled may then be determined so that these users-to-be-polled are likely to have knowledge (or have access to knowledge) regarding such subject matter about which a query has been initiated. At least some of the determined users-to-be-polled are not currently accessing the particular web property or subject matter, e.g., may be accessing a different web property. Since the users-to-be-polled can include both users who are and are not accessing the particular web property of the originating query, the determined users-to-be-polled can form a diverse set of online users who can provide helpful information regarding the particular query. This determined set of online users is then polled with the query initiated by the querying user, and the one or more answers provided by such polled users are then provided to the querying user.

### BACKGROUND OF THE INVENTION

The field of the invention pertains to systems for sharing knowledge among users over a computer network.

The Internet provides a number of mechanisms that allow a user to find answers to questions, as well as contribute shared content. A web property may be loosely defined as a web service or site that provides information regarding a particular type of subject matter to querying users. By way of an example, Yahoo! Maps by Yahoo! Inc. of Sunnyvale, Calif. provides a map property that allows users to obtain map and directional information regarding a wide variety and number of locations. Another web property may allow a user to provide content regarding a particular type of subject matter and this contributed content can be shared among users who access such same web property. For example, Yahoo! Local by Yahoo! Inc. of Sunnyvale, Calif. provides a local web property by which users can obtain and provide information regarding businesses and services which are local to such users.

The downside to the typical web property arrangement is that the community contributions for a particular web property are collected only during access to such specific property. Said in another way, this arrangement limits who can contribute to a particular property by only allowing sharing of contributions between users of a same web property.

Accordingly, it would be beneficial to provide improved mechanisms for contributing and sharing information among users.

### SUMMARY OF THE INVENTION

Apparatus and methods for facilitating online user polling over a computer network are provided. In general, a particular web property is a web service or site that is related to a particular type of subject matter or service. A user of a particular web property can select a polling feature and initiate a query regarding a particular subject matter that is related to such particular web property. A set of online users-to-be-polled may then be determined so that these users-to-be-polled are likely to have knowledge (or have access to knowledge) regarding such subject matter about which a query has been initiated. At least some of the determined users-to-be-polled are not currently accessing the particular web property or subject matter, e.g., may be accessing a different web property. Since the users-to-be-polled can include both users who are and are not accessing the particular web property of the originating query, the determined users-to-be-polled can form a diverse set of online users who can provide helpful information regarding the particular query. This determined set of online users is then polled with the query initiated by the querying user, and the one or more answers provided by such polled users are then provided to the querying user.

In another embodiment, the invention pertains to an apparatus having at least a processor and a memory. The processor and/or memory are configured to perform one or more of the above described operations. In another embodiment, the invention pertains to at least one computer readable storage medium having computer program instructions stored thereon that are arranged to perform one or more of the above described operations.

These and other features of the present invention will be presented in more detail in the following specification of the invention and the accompanying figures which illustrate by way of example the principles of the invention.

### BRIEF DESCRIPTION OF THE DRAWINGS

FIG. 1 illustrates an example network segment in which the present invention may be implemented in accordance with one embodiment of the present invention.

FIG. 2 is a flow chart illustrating a polling management procedure in accordance with one embodiment of the present invention.

FIG. 3 represents a screen shot of a map web property in accordance with a specific implementation.

FIG. 4 represents a screen shot of a local web property in accordance with a specific implementation.

FIG. 5A represents screen shot of an answers web property before a query has been submitted in accordance with a specific implementation.

FIG. 5B represents screen shot of an answers web property after a query has been submitted in accordance with a specific implementation.

FIG. 6 illustrates an example computer system in which specific embodiments of the present invention may be implemented.

### DETAILED DESCRIPTION OF THE SPECIFIC EMBODIMENTS

Reference will now be made in detail to a specific embodiment of the invention. An example of this embodiment is illustrated in the accompanying drawings. While the invention will be described in conjunction with this specific embodiment, it will be understood that it is not intended to limit the invention to one embodiment. On the contrary, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In other instances, well known process operations have not been described in detail in order not to unnecessarily obscure the present invention.

In general, a flexible and extensible polling arrangement is provided. When online user contributions for a particular subject matter are desired, selected online users are polled based on a priori knowledge of such online users, the locations of the online users (e.g., based on IP addresses), and the particular web properties which online users are currently using. This polling schema solicits contributions from these selected users, and answers from such polled users may then be provided in real time to the querying users.

Online users may initiate queries and be polled as they are accessing a diverse number and type of different web properties. A web property typically provides a particular type of service to users via one or more associated web pages. The web property may be related to one or more specific types of subject matter. For example, a mapping property may provide directions or maps for particular addresses or businesses, such as Yahoo! Maps available from Yahoo! Inc., of Sunnyvale, Calif. Another example is a local web property that serves to provide information regarding a particular geographical area, e.g., its businesses, people, entertainment, etc, such as Yahoo! Local available from Yahoo! Inc. Another web property may provide a network answering system in which users can submit questions to a community of users who can then choose to share knowledge with such querying users (e.g., Yahoo! Answers, available from Yahoo! Inc. of Sunnyvale, Calif.). One or more people from this answering community may submit an answer to a particular question.

A web property may take any suitable form, such as a web site for purchasing particular products or services, managing photographs and videos, personals, real estate, shopping, jobs, games, finance, automobiles, health, or sharing information regarding any number and type of specific topics (e.g., relationships, family, religion, health, hobbies, sports, travel, shopping, household management, astrology, art, entertainment, philosophy, fashion, sex, finance, career, business, law, politics, education, green and eco-friendly topics, etc.).

In a specific mapping web property example, a querying user may be accessing a particular address or business of a mapping property. When accessing a particular location or business, such as a restaurant, the querying user may wish to ask a question about such location or business. After a user initiates a query about a particular location or business, online users who may have relevant knowledge regarding such location or business may be polled with the query and any returned answers from the polled users may then be provided to the querying user.

Although certain embodiments are described herein in relation to particular web properties, it should be apparent that online polling management may also be provided in other web properties. It should also be noted that embodiments of the invention are contemplated in which the operation of the underlying web property is largely unaffected by the overlying polling management system. For instance, in a mapping property, a mapping engine may acquire information relating to particular addresses or locations as it would conventionally, i.e., without the benefits of or reference to the polling mechanisms enabled by the present invention. For example, query and polling handling techniques may be applied after maps or directions regarding a particular address are obtained for the querying user. However, embodiments are also contemplated in which the operation of the underlying web property engine is altered based on query or polling information in some way to enable at least some further web property enhancements. For example, polling results regarding a particular business or organization at the queried address, which was previously provided by polled users, may be presented alongside map or direction information for such queried address.

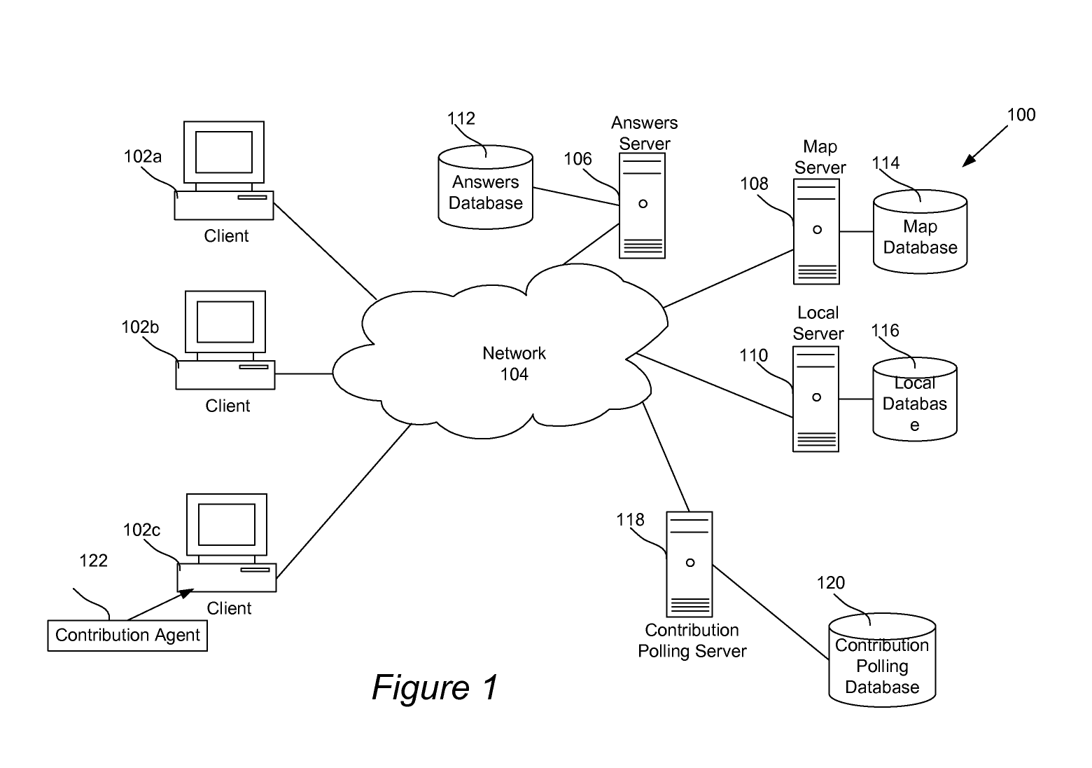

Prior to describing mechanisms for user polling, a computer network architecture will first be briefly described to provide an example context for practicing techniques of the present invention. FIG. 1 illustrates an example network segment 100 in which the present invention may be implemented in accordance with one embodiment of the present invention. As shown, a plurality of clients 102a-c may access a map application, for example, on map server 108 via network 104 and/or access a local service, for example, on local server 110 via network 104. A client 102 may also access an answers service, for example, on answers server 106, via network 104.

Clients and servers may communicate with each other via any suitable number and type of network, illustrated by network 104. The network 104 may take any suitable form, such as a wide area network or Internet and/or one or more local area networks (LAN's). The network 104 may include any suitable number and type of devices, e.g., routers and switches, for forwarding service requests from each client to a server and forwarding service results back to the requesting clients, as well as forwarding communications between servers and between clients.

Certain embodiments of the invention may also be practiced in a wide variety of network environments (represented by network 104) including, for example, TCP/IP-based networks, telecommunications networks, wireless networks, etc. In addition, the computer program instructions with which embodiments of the invention are implemented may be stored in any type of computer-readable media, and may be executed according to a variety of computing models including a client/server model, a peer-to-peer model, on a stand-alone computing device, or according to a distributed computing model in which various processes described herein may be effected or employed at different locations.

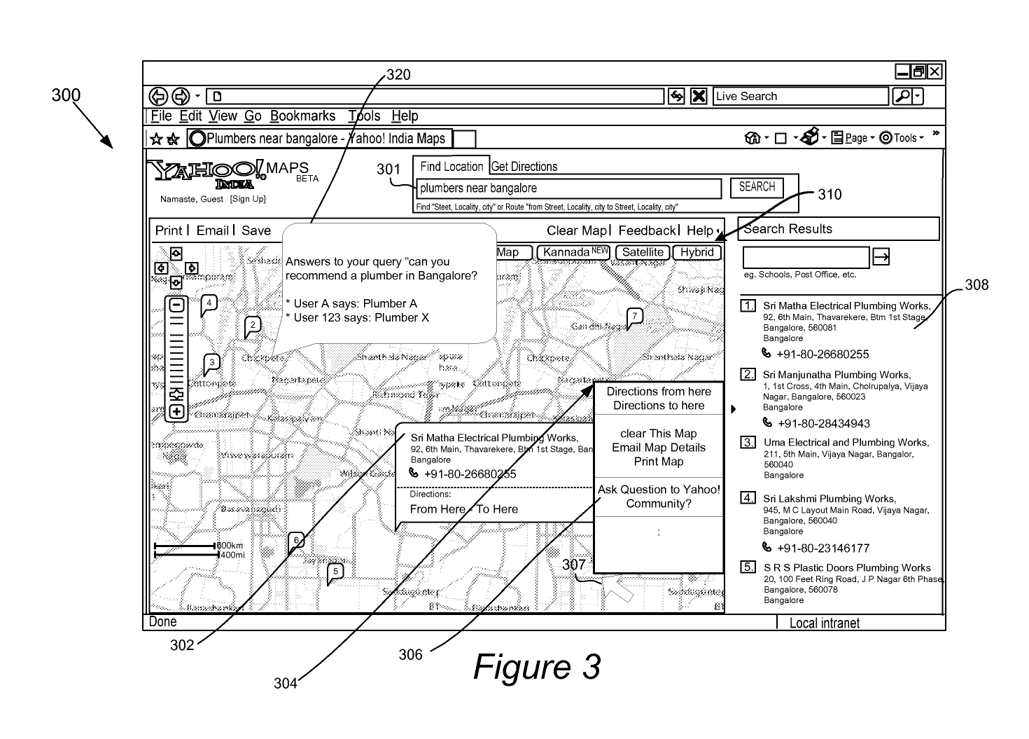

Map server 108 (or servers) provides driving directions and map information regarding a particular address, location, intersection, business, organization, or the like that is input by a user. FIG. 3 represents a screen shot of a map web property, in which a query for “plumbers near Bangalore” 301 has been performed so as to present a map view 300 to the querying user. The map view 300 presents the general Bangalore area and a specific business listing 302 related to the specific query for “plumbers near Bangalore”. Other types of views, such as satellite, colloquial, or a hybrid view, may be selected via viewing options 310, and other business listings (e.g., plumbers near Bangalore) are also listed in side search results window 308.

The map server 108 (or servers) may have access to one or more map database(s) 114 into which map and direction information, as well as business or organization information, is retained. The map database may include any suitable data, e.g., text or image data, which can be used to render a map for a particular address or geographical location. For instance, the map database 114 may include image data for rendering different types of visual maps, attribute data for displaying various map attributes, such as color, language, line widths or schema, etc. (which may vary based on user or client capability), as well as other related information that is associated with each map portion, such as points of interest, advertisement data, etc. Several embodiments of a mapping web property are described further in U.S. Patent Application, having Publication Number 2008/0109159, published 8 May 2008, by Norman X. Shi et al., which patent application is incorporated herein by reference in its entirety.

Local server 110 (or servers), such as Yahoo! Local from Yahoo! Inc. of Sunnyvale, Calif., allows business or organization owners to add searchable listing for particular locations, areas, cities, etc. Users can search for particular businesses or organizations in a particular area or location. Users may also add reviews for such businesses or organizations. The local server 110 (or servers) may access one or more local database(s) 116 for retaining local information for each business or organization, such as a description, reviews, directions, a URL (universal resource locator), coupons, etc.

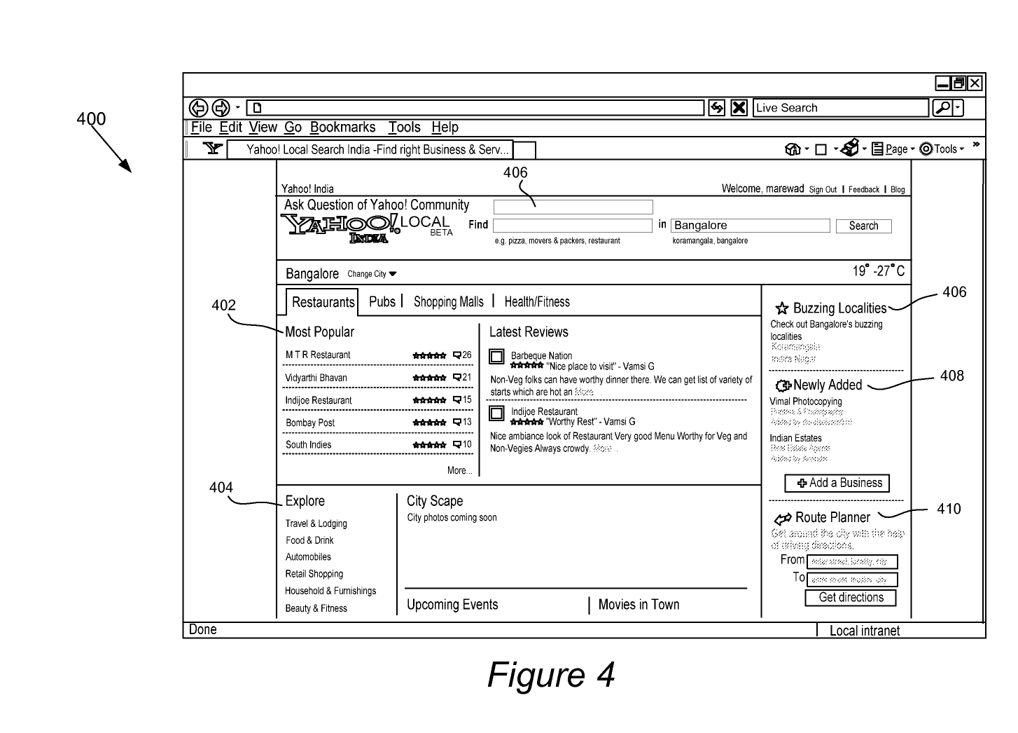

FIG. 4 represents a screen shot of a local web property for Bangalore, India, in which a query has not been performed so that a home local page 400 is presented. The home page includes a listing of the most popular restaurants 402, exploration options 404, a listing of businesses about which are frequently talked (“buzzing localities”) 406, a list of newly added businesses 408, and a route planner 410, etc.

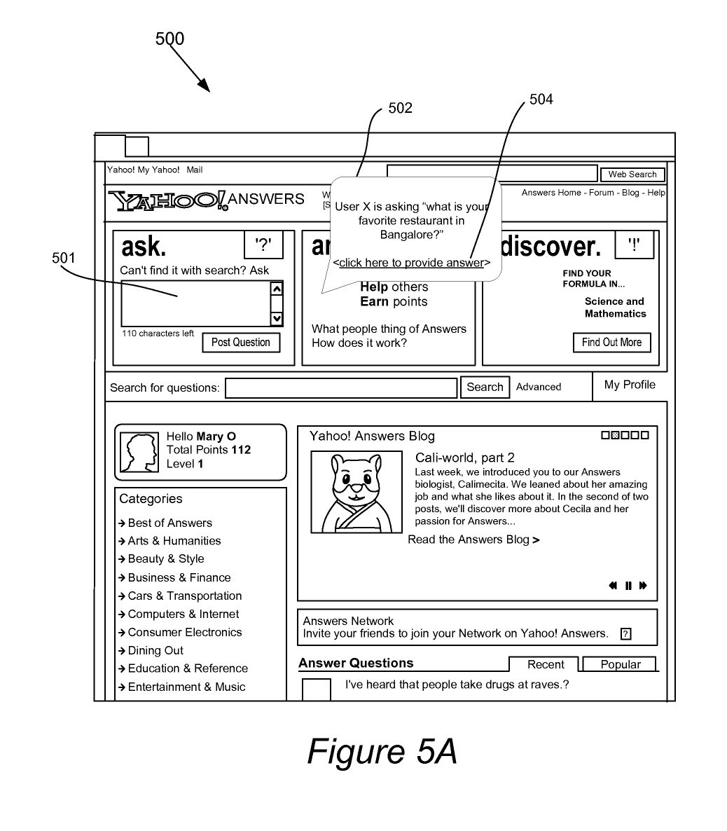

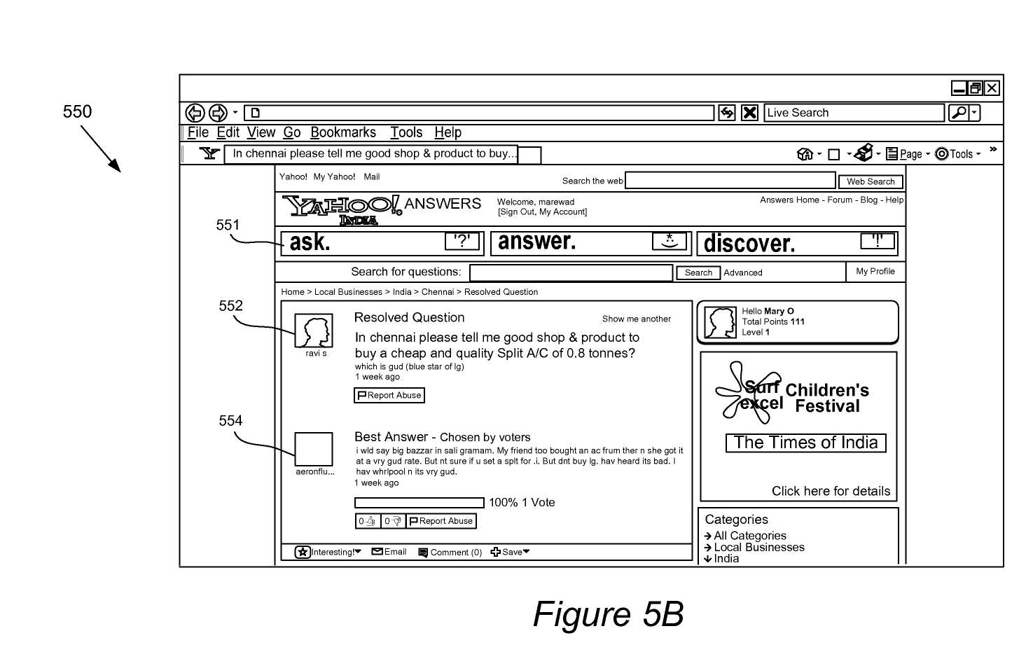

Answers server 106 (or servers) allows users to submit a question. Other users can then view and answer a question by accessing the answers server 106, and these answers are provided by different users over a period of time, e.g., days. Answers server 106 (or servers) may have access to one or more answers database 112 for retaining question and answers information. FIG. 5B represents a screen shot 550 of an answers web property for India, in which a query 552 has been performed so that the query 552 and resulting answers 554 are presented.

Embodiments of the present invention improve upon this type of answering system by polling a selected set of online users upon initiation of a query by a user. Since the polled users are online, answers may be received in a timelier manner, as compared to conventional answering systems. Since the polled users are selected based on their likelihood to provide relevant answers, the polled users are more likely to respond to the query and the answers will more likely be relevant for the particular query.

In a specific implementation, a contribution polling server 118 (or servers) may be configured to enable users to make queries to a diverse and selected set of online users. The contribution polling server 118 (or servers) may also access one or more contribution polling database(s) 120 for retaining query data, answers data, etc. as described further herein.

In a specific implementation, one or more clients may also be configured with a contribution agent, e.g., 122. The contribution agent may be configured to intercept requests from the client for any object, such as a web page to a particular service provider, before forwarding such request to its service provider. For instance, the client browser may include a contribution agent in the form of a plug-in that receives URL (universal resource locator) requests made by the user for particular web pages. The contribution agent can as an intermediary software layer between the browser and web servers. Accordingly, any number and type of data (e.g., the web page, as well as with other information such as an identification of the user, the web page identification and/or URL, and timestamps for accessing and exiting such result object, etc.) may be collected from users (e.g., with permission) to facilitate polling selection.

Although the contribution polling server 118 is shown as a separate server, the contribution polling server 118 and/or the contribution polling database(s) 120 may be merged with answers server 106, map server 108, local server 110 and/or any of their corresponding database(s) and/or contributions agent 122.

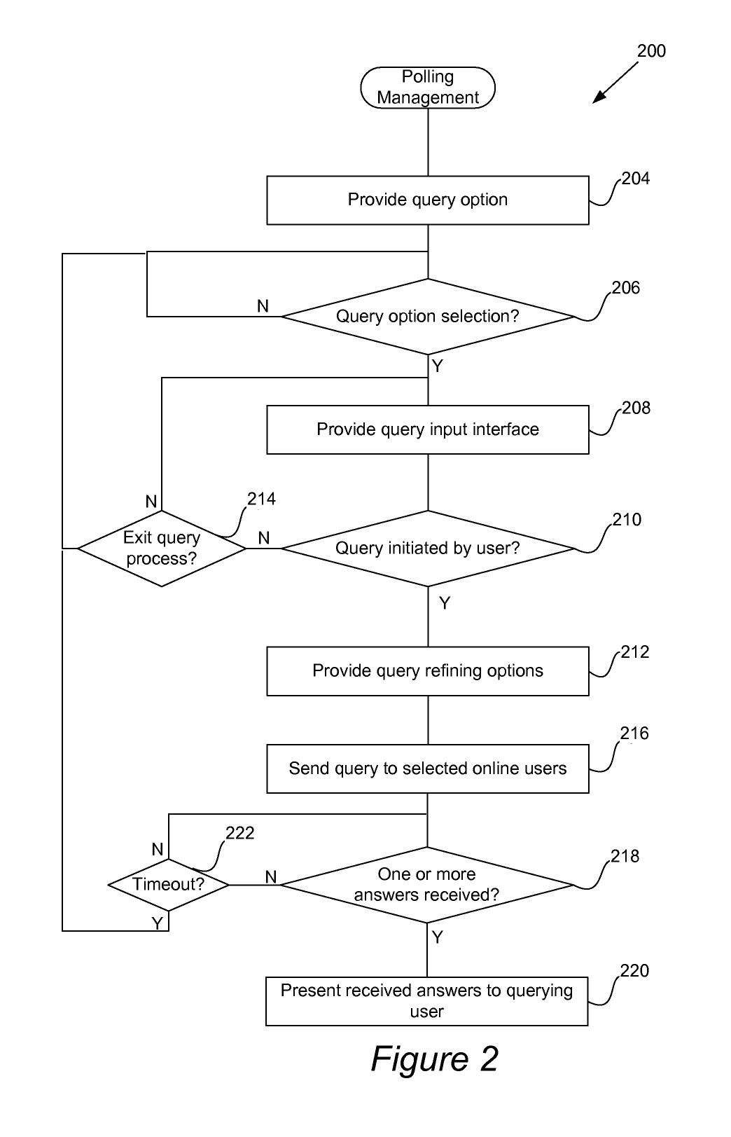

Regardless of the specific architecture, any suitable mechanism for allowing users to query and poll selected online users may be provided. FIG. 2 is a flow chart illustrating a polling management procedure 200 in accordance with one embodiment of the present invention. Initially, a query option may be provided in operation 204. A query option may be provided in any suitable web property so that a user may initiate a query from such web property. A query option may take any suitable form for initiating a query. By way of examples, a query option may be presented or accessed via a pull-down menu, pop-up window, link, a static or floating input mechanism, etc. In the map web property of FIG. 3, a query option 306 is accessible via a pull-down menu 304. In the local web property of FIG. 4, a query option takes the form of a static text input box 406.

It may also be determined whether a query option has been selected in operation 206. A user may select a query by selecting a query option, for example, by any suitable manner. A query may be initiated by selecting the query option from a pull-down menu, inputting text into a query option input box, selecting a link, etc. As shown in FIG. 3, a query option may be displayed in a window 304, for example, when a user right clicks over the displayed map page 300 with their mouse or other pointing device 307.

If a user has not yet selected a query option, the procedure may continue to wait for such selection or the polling procedure is only triggered when a user selects such option.

When a user selects a query option, a query input interface may optionally be provided to the user if needed in operation 208. For example, if the user selects the query option, e.g., 306, of a pull-down menu, e.g., 304, an input box may then be presented to the user for entry of a query. Of course, if the query option is presented on the web property as a static or floating input box, e.g., 406, this type of query option already includes an input interface so that the user may select such query option by typing text into such input interface. In this case, it is unnecessary to provide a separate input interface in operation 208.

It may also be determined whether the user has initiated a query option in operation 210. The user may have initiated a query by typing into an input box (e.g., 406 of FIG. 4) or selecting a query option (e.g., 306 of FIG. 3) and then entering a query into a subsequently provided input box or the like (not shown). A query may also be initiated in an answers web property, such as the answers web property view 500 illustrated in FIG. 5A. In the implementation of FIG. 5A, users can initiate a query by selecting the “Ask” link 501 and then typing their query into a subsequently provided input interface (not shown).

If a query has been initiated, query refining options may also be provided to the user in operation 212. Refining options may be based on the context of the query. If a query is presented in a map web property, the user may be asked whether he/she wishes to limit their query to a particular radius with respect to the geographical location from which the query was initiated on a map. The query may be analyzed to extract words that belong to predefined categories and the user may be asked to narrow their query to a particular subcategory. For example, if the user types a query about computers, a refining option may ask the user to select either a Macintosh or a PC type computer. Additionally, as queries and answers are collected over time, such queries and answers may be analyzed to provide further refinement options. For instance, if numerous queries with the word Jaguar result in answers pertaining to an animal and a car, users may be asked to clarify whether their query pertains to animals or cars

Query refinement options may also be provided to the user through any suitable interface, such as a pop-up or pull-down window. The refinement options may also allow querying users to define permission setting for the query (e.g., only query friends within the user's social network), add a comment or tag for the query, submit the query for the current page, submit the query for a currently selected object, select to have the query (and answers) stored at the user's (client) site or at the content publisher's site or if the query is captured by a contribution agent, then at the site of the agent manager, etc.

Another query refinement option may allow the user to add any suitable comments or tags for the currently defined query. By way of examples, the comments or tags may refer to additional information, a review or a metric regarding an object, place, or person that is represented in the query or web page for which a query is being initiated. For example, the user may add a review about a particular product or service that is represented within the query or web page and about which a query is being initiated. In a specific example, the user may add a review for a particular restaurant that is represented in the query or web page by an identifying text string (e.g., restaurant name), an image or video of the restaurant, etc. A metric for the query's area or object of interest may include a vote, a ranking value, a score, a time duration, a click frequency, a click count, etc. In a tagging example, a user may select from a predefined list of tags or enter a custom tag. The tag may include any additional information regarding a query, object, place, or person represented in the web pages about which a query is being made, such as providing a category for the object or associating one or more users with the object. Such tag or other refinement information may be retained by the particular web property server (e.g., in an associated database) and later presented in the web property to the same or different users of such web property.

Regardless of whether refining options are provided and whether a user selects additional refinement options, the query (or refined query) is sent to selected online users in operation 216. When a querying user of a particular web property selects a query option and initiates a query regarding a particular subject matter of such particular web property, a set of online users-to-be-polled, who is each likely to have access to knowledge regarding such particular subject matter, is generally determined. A set of users may be determined to be online when they have logged into a particular service, such as Yahoo!, accessed such service using a particular device ID, or the like.

The online users-to-be-polled may then be selected using any suitable criteria so that such users are most likely to provide relevant answers to the particular query. Information that was previously retained for particular users in one or more user databases (such as answers database 112 or a user search database-not shown) may be analyzed to determine which online user is likely to have knowledge regarding the particular subject matter of a query. User information may be associated with a particular user identifier (ID), such as a login ID or device ID (e.g., MAC or static IP address). The subject matter of the query may be determined by parsing through the query to determine whether particular words belong to a particular predefined category.

In one embodiment, the set of online users-to-be-polled is determined by selecting online users which have previously answered the most questions regarding the particular subject matter of the query. For instance, an answers server retains category information regarding queries and answers and their associated users in an answers database. Answers from particular users may also be rated by other users, and such ratings can also be associated with the user data of the answers database. This answers database can then be searched to find users who meet relevancy criteria, such as providing the highest number of or most highly rated answers for a particular category in which the current query belongs. These users that meet the relevancy criteria can then be selected to be polled for the current query. In another embodiment, category and/or rating information may be retained (e.g., in a contribution polling or other database) regarding users who have previously provided answers in response to being polled, and such polling information may then be used to determine the users who meet a relevancy criteria.

In another aspect, the set of online users-to-be-polled may be determined by selecting online users which are currently accessing a web property that pertains to the particular subject matter of the query. For example, a person looking for a restaurant location may receive in real time personalized feedback about a particular restaurant from users who are accessing other properties related to food, drinks, eating and restaurants, etc. In another example, a query for camera advice may result in users of a photograph web property (e.g., Flickr from Yahoo!), who have submitted photos using the same camera model of interest, to be selected for polling. In yet another example, a query about car dealerships in Bangalore may result in Bangalore users, who are viewing auto related properties, to be selected for polling.

In yet another embodiment, the set of online users-to-be-polled is determined by selecting online users which are currently at a physical location (e.g., based on an IP address) that pertains to the particular subject matter of the query. In the above restaurant query example, users in the same general area of the queried restaurant may be selected for polling.

The determined online users are polled with the query that was initiated by the querying user. This polling is performed regardless of whether the polled user is accessing a same web property as the querying user. Thus, at least some of the polled users are not accessing the particular web property of the querying user while being polled. Additionally, different polled users will likely be accessing different web properties. For example, the querying user initiates a query in a map or local web property, and a user is polled while accessing an answers web property and another user is polled while accessing an auto web property.

Users may be polled in a number of ways. In one example, polling is accomplished by presenting the query to the polled users via an answers web property that allows users to submit questions and provide answers. As shown in FIG. 5B, a query 552 is presented in answers web property view 550, along with an answer 554 to such query 552. In specific implementations, a polled user can be presented with a query in an email, text message, audio message sent to a computer, PDA (personal digital assistant), phone, etc., static or floating pop-up window, chat session, video, etc., or any combination thereof, while the querying user is accessing a particular web property.

In the answers web property of FIG. 5A, a floating pop-up window 502 is presented to the polled user. This floating pop-up window 502 includes a link 504 that is selectable so that the polled user may provide an answer to the querying user. The presented question (e.g., “what is your favorite restaurant in Bangalore?”) may be presented so that the querying user is identified or not. Polled users may be incentivized to provide answers, e.g., receive a discount coupon for a product or service, points, cash, etc.

Referring back to FIG. 2, it may then be determined whether one or more answers have been received in operation 218. If one or more answers are received, the returned answers are then presented to the querying user in operation 220. Answers may be compiled over a period of time and presented together to the querying users or presented one at a time as the answers are received, e.g., by the contribution server 118.

The answers may be presented to the querying user in any suitable manner. For example, answers can be presented in an email, text message, audio message sent to a computer, PDA (personal digital assistant), phone, etc., static or floating pop-up window, chat session, video, etc., or any combination thereof, while the querying user is accessing a particular web property. In the answers example of FIG. 5B, when an answer 554 is received for the query, this answer can then be sent to the querying user, e.g., within the querying user's particular web property. In another implementation, the querying user is directed to an answers web property, such as answers property 550 of FIG. 5B, in which his/her query 552 has been input and an answer 554 received. In the map example of FIG. 3, the querying user has made a query “can you recommend a plumber in Bangalore” in the map property and received his/her answers in a static pop-up window 320 in the same map property. Any suitable type of answers web property features may be provided along with the answers provided to the querying user. Several answers features are further described in U.S. Patent Application, having Publication Number 2008/0133671, published 5 Jun. 2008, by Chris T. Kalaboukis, which patent application is incorporated herein by reference in its entirety.

Otherwise, if an answer has not been received, it may be determined whether a predefined time out has occurred in operation 222. When a time out occurs, the polling process may restart at operation 206. Otherwise, the polling process continues to wait for returned answers in operation 218.

If a query has not been initiated, it may be determined whether the query process has been exited in operation 214. For instance, the user may exit the options window 304 (or additional query input interface) by clicking elsewhere on the web page or hitting the “ESC” key. If the query process has been exited, the procedure 200 may return to determining whether another query option has been selected again for the current page in operation 206. If the query process has not exited (e.g., the options window 304 is still open), the procedure 200 may continue to provide a query input interface (operation 208) and wait for initiation of a query in operation 206.

The procedure 200 may be repeated for the current page or any portion of such page. Of course, the process of FIG. 2 may also be applied to a plurality of same or different users as they access the same or different web pages.

Certain embodiments of the present invention, in effect, allow a user of a web property to be connected to a diverse set of users, regardless of their current web property access, so as to form a large online community of collaborators. When an answer is presented to a querying user, an option to contact the answering user may also be provided so that the querying and answering user may conduct a real time conversation (e.g., through a chat or instant messaging session). Additional information may then be easily shared between users.

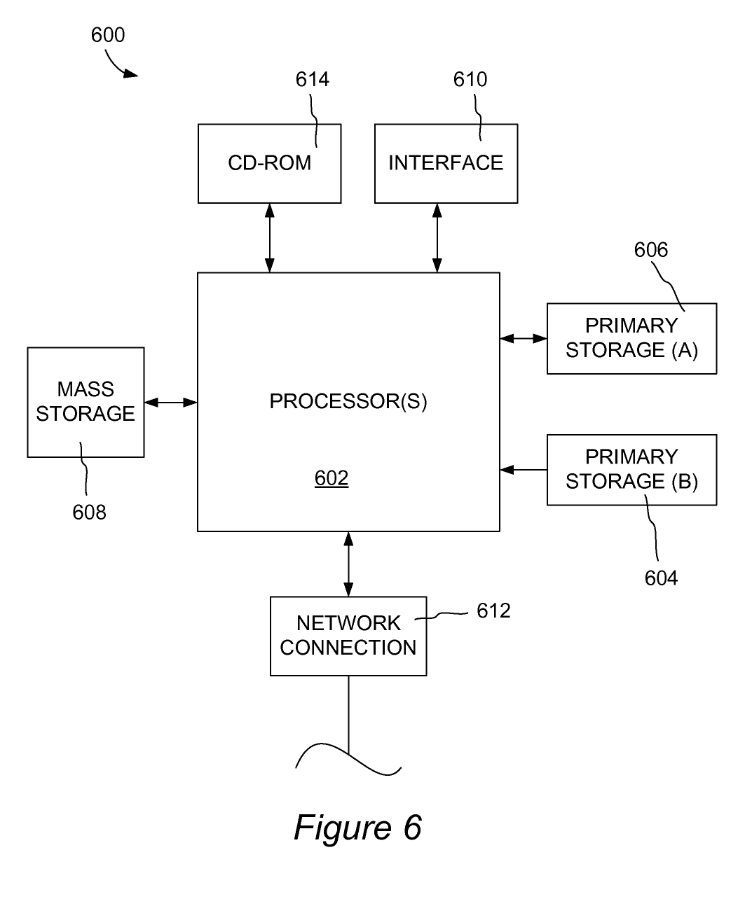

The present invention may be implemented in any suitable combination of hardware and/or software. FIG. 6 illustrates a typical computer system that, when appropriately configured or designed, can serve as a contribution polling manager of this invention. The computer system 600 includes any number of processors 602 (also referred to as central processing units, or CPUs) that are coupled to storage devices including primary storage 606 (typically a random access memory, or RAM), primary storage 604 (typically a read only memory, or ROM). CPU 602 may be of various types including microcontrollers and microprocessors such as programmable devices (e.g., CPLDs and FPGAs) and unprogrammable devices such as gate array ASICs or general purpose microprocessors. As is well known in the art, primary storage 604 acts to transfer data and instructions uni-directionally to the CPU and primary storage 606 is used typically to transfer data and instructions in a bi-directional manner. Both of these primary storage devices may include any suitable computer-readable media such as those described above. A mass storage device 608 is also coupled bi-directionally to CPU 602 and provides additional data storage capacity and may include any of the computer-readable media described above. Mass storage device 608 may be used to store programs, data and the like and is typically a secondary storage medium such as a hard disk. It will be appreciated that the information retained within the mass storage device 608, may, in appropriate cases, be incorporated in standard fashion as part of primary storage 606 as virtual memory. A specific mass storage device such as a CD-ROM 614 may also pass data uni-directionally to the CPU.

CPU 602 is also coupled to an interface 610 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 602 optionally may be coupled to an external device such as a database or a computer or telecommunications network using an external connection as shown generally at 612. With such a connection, it is contemplated that the CPU might receive information from the network, or might output information to the network in the course of performing the method steps described herein.

Regardless of the system's configuration, it may employ one or more memories or memory modules configured to store data, program instructions for the general-purpose processing operations and/or the inventive techniques described herein. The program instructions may control the operation of an operating system and/or one or more applications, for example. The memory or memories may also be configured to store queries, answers, user information, web property information, timeout amounts, etc.

Because such information and program instructions may be employed to implement the systems/methods described herein, the present invention relates to machine readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). The invention may also be embodied in a carrier wave traveling over an appropriate medium such as air, optical lines, electric lines, etc. Examples of program instructions include both machine code, such as produced by a compiler, and files containing higher level code that may be executed by the computer using an interpreter.

Although the foregoing invention has been described in some detail for purposes of clarity of understanding, it will be apparent that certain changes and modifications may be practiced within the scope of the appended claims. Therefore, the present embodiments are to be considered as illustrative and not restrictive and the invention is not to be limited to the details given herein, but may be modified within the scope and equivalents of the appended claims.

What is claimed is:

1. A method of facilitating online user polling over a computer network, comprising:
when a querying user of a particular web property selects a query option and initiates a query regarding a particular subject matter of such particular web property, determining a set of online users-to-be-polled who are likely to have access to knowledge regarding such particular subject matter; and
polling the determined set of online users-to-be-polled with the query that was initiated by the querying user whereby at least some of the polled users are not accessing the particular web property while being polled; and
when one or more answers are provided by one or more of the polled users, providing such one or more answers to the querying user.

2. A method as recited in claim 1, wherein polling is accomplished by presenting the query to the polled users via an answers web property that allows users to submit questions and provide answers.

3. A method as recited in claim 2, wherein the particular web property, in which the query was initiated by the querying user, is a different web property than the answers property.

4. A method as recited in claim 3, wherein the particular web property, in which the query was initiated by the querying user, is a mapping property that provides directions regarding specific locations or a local property that allows users to share information regarding services and places.

5. A method as recited in claim 1, further comprising:
providing query refinement options to the querying user; and
if the user modifies their query based on the query refinement options, using the modified query in the polling,
wherein the query refinement options prompt the user to specify a radius from a particular location being accessed in the particular web property or to specify a particular category of the subject matter of the query.

6. A method as recited in claim 1, wherein the set of online users-to-be-polled is determined by selecting online users which have previously answered questions the most regarding the particular subject matter of the query.

7. A method as recited in claim 1, wherein the set of online users-to-be-polled is determined by selecting online users which are currently accessing a web property that pertains to the particular subject matter of the query.

8. A method as recited in claim 1, wherein the set of online users-to-be-polled is determined by selecting online users which are currently at a physical location that pertains to the particular subject matter of the query.

9. An apparatus comprising at least a processor and a memory, wherein the processor and/or memory are configured to perform the following operations:
when a querying user of a particular web property selects a query option and initiates a query regarding a particular subject matter of such particular web property, determining a set of online users-to-be-polled who are likely to have access to knowledge regarding such particular subject matter; and
polling the determined set of online users-to-be-polled with the query that was initiated by the querying user whereby at least some of the polled users are not accessing the particular web property while being polled; and
when one or more answers are provided by one or more of the polled users, providing such one or more answers to the querying user.

10. An apparatus as recited in claim 9, wherein polling is accomplished by presenting the query to the polled users via an answers web property that allows users to submit questions and provide answers.

11. An apparatus as recited in claim 10, wherein the particular web property, in which the query was initiated by the querying user, is a different web property than the answers property.

12. An apparatus as recited in claim 11, wherein the particular web property, in which the query was initiated by the querying user, is a mapping property that provides directions regarding specific locations or a local property that allows users to share information regarding services and places.

13. An apparatus as recited in claim 9, wherein the processor and/or memory are further configured to perform the following operations:
providing query refinement options to the querying user; and
if the user modifies their query based on the query refinement options, using the modified query in the polling,
wherein the query refinement options prompt the user to specify a radius from a particular location being accessed in the particular web property or to specify a particular category of the subject matter of the query.

14. An apparatus as recited in claim 9, wherein the set of online users-to-be-polled is determined by selecting online users which have previously answered questions the most regarding the particular subject matter of the query.

15. An apparatus as recited in claim 9, wherein the set of online users-to-be-polled is determined by selecting online users which are currently accessing a web property that pertains to the particular subject matter of the query.

16. An apparatus as recited in claim 9, wherein the set of online users-to-be-polled is determined by selecting online users which are currently at a physical location that pertains to the particular subject matter of the query.

17. At least one computer readable storage medium having computer program instructions stored thereon that are arranged to perform the following operations:
when a querying user of a particular web property selects a query option and initiates a query regarding a particular subject matter of such particular web property, determining a set of online users-to-be-polled who are likely to have access to knowledge regarding such particular subject matter; and
polling the determined set of online users-to-be-polled with the query that was initiated by the querying user whereby at least some of the polled users are not accessing the particular web property while being polled; and
when one or more answers are provided by one or more of the polled users, providing such one or more answers to the querying user.

18. At least one computer readable storage medium as recited in claim 17, wherein polling is accomplished by presenting the query to the polled users via an answers web property that allows users to submit questions and provide answers.

19. At least one computer readable storage medium as recited in claim 18, wherein the particular web property, in which the query was initiated by the querying user, is a different web property than the answers property.

20. At least one computer readable storage medium as recited in claim 19, wherein the particular web property, in which the query was initiated by the querying user, is a mapping property that provides directions regarding specific locations or a local property that allows users to share information regarding services and places.

21. At least one computer readable storage medium as recited in claim 17, wherein the computer program instructions stored thereon that are further arranged to perform the following operations:
providing query refinement options to the querying user; and
if the user modifies their query based on the query refinement options, using the modified query in the polling,
wherein the query refinement options prompt the user to specify a radius from a particular location being accessed in the particular web property or to specify a particular category of the subject matter of the query.

22. At least one computer readable storage medium as recited in claim 17, wherein the set of online users-to-be-polled is determined by selecting online users which have previously answered questions the most regarding the particular subject matter of the query.

23. At least one computer readable storage medium as recited in claim 17, wherein the set of online users-to-be-polled is determined by selecting online users which are currently accessing a web property that pertains to the particular subject matter of the query.

24. At least one computer readable storage medium as recited in claim 17, wherein the set of online users-to-be-polled is determined by selecting online users which are currently at a physical location that pertains to the particular subject matter of the query.
